(19) United States
(12) Patent Application Publication
(10) Pub. No.: US 2004/0181782 A1
(43) Pub. Date: Sep. 16, 2004

(54) System and method for optimizing memory usage by locating lingering objects

(76) Inventor: Piotr Findeisen, Plano, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/389,015

(22) Filed: Mar. 13, 2003

(51) Int. Cl. G06F 9/44; G06F 9/45

(52) U.S. Cl. 717/130; 717/154

(57) ABSTRACT

A system and method for optimizing memory usage by automatic detection of likely lingering objects are disclosed. In one embodiment, an object reference graph associated with the software application is analyzed to determine which objects in the heap are likely to have become lingering objects based on a heuristic criteria profile. A metric, i.e., a numerical value associated with objects, is offered by the method to assess the impact of the possible lingering objects on the heap in a measurable way.

### CROSS-REFERENCE TO RELATED APPLICATION(S)

This application discloses subject matter related to the subject matter disclosed in the following commonly owned co-pending patent application: “A SYSTEM AND METHOD FOR DETERMINING DEALLOCATABLE MEMORY IN A HEAP,” filed ______, Ser. No.: ______ (Docket Number: 200309975-1), in the name of Piotr Findeisen, incorporated by reference herein.

### BACKGROUND

Object oriented programming is a well-known software application development technique that employs collections of objects or discrete modular data structures that are identified by so called references. More than one reference can identify the same object. The references can be stored in the application variables and within the objects, forming a network of objects and references, known as the reference graph. The objects are created dynamically during the application execution, and are contained in a memory structure referred to as a heap.

Many object oriented programming languages, such as Java, Eiffel, and C sharp (C#), employ automatic memory management, popularly known as garbage collection. Automatic memory management is an active component of the runtime system associated with the implementation of the object oriented language, which removes unneeded objects from the heap during the application execution. An object is unneeded if the application will no longer use it during its execution. A common way of determining at least a substantial subset of the unneeded objects is to determine so called “liveness” of all objects in the heap. An object is defined as “live” if there exists a path of references starting from one of the application variables, and ending at the reference to the given object. A path of references is defined as a sequence of references in which each reference with the exception of the first reference in the sequence is contained within the object identified by the previous reference in the sequence.

A frequent problem appearing in object oriented applications written in languages with automatic memory management is that some objects due to the design or coding errors remain live, contrary to the programmer's intentions. Such objects are called lingering objects. Lingering objects tend to accumulate over time, clogging the heap and causing multiple performance problems, eventually leading to the application crash.

To detect the lingering objects, programmers in the development phase of the application life-cycle employ memory debugging or memory profiling tools. In one widely practiced debugging methodology, the tool produces a heap dump which serves as a baseline snapshot that illustrates the objects residing in the heap at the given time. A set of test inputs is then run through the program and the tool produces a second snapshot of the heap which illustrates the objects residing in the heap at the second time. The programmer then compares the two snapshots to determine which objects are accumulating over time. By analyzing the reference graphs contained in the heap dumps, and using his/her skills and the knowledge of the program logic, the programmer can determine which objects are lingering, and, what is even more important, why they stay alive. Then the programmer can proceed with fixing the application program in such a way that no more reference paths to the lingering objects can be found by the garbage collector.

Despite the acceptance of the existing approaches to finding lingering objects, they are tedious to use, and do not easily scale in production environment, where the heap sizes can be of order of gigabytes.

### SUMMARY

A system and method for optimizing memory usage by automatic detection of likely lingering objects are disclosed. In one embodiment, an object reference graph associated with the software application is analyzed to determine which objects in the heap are likely to have become lingering objects based on a heuristic criteria profile. A metric, i.e., a numerical value associated with objects, is offered by the method to assess the impact of the possible lingering objects on the heap in a measurable way.

### BRIEF DESCRIPTION OF THE DRAWINGS

FIG. 1A depicts a functional block diagram illustrating a lingering object engine being employed in a design tool environment, i.e., a development environment;

FIG. 1B depicts a functional block diagram illustrating a lingering object engine being employed in a virtual machine environment, i.e., a production environment;

FIG. 1C depicts a functional block diagram of one embodiment of a lingering object engine being employed within a diagnostic tool in a production environment;

FIG. 2 depicts a block diagram of one embodiment of a hardware platform which includes a multiprocessing system for supporting the lingering object engine of FIG. 1A, FIG. 1B or FIG. 1C;

FIG. 3 depicts a schematic diagram of one embodiment of a system employing a traversing and tabulation engine for determining lingering objects located in a heap space;

FIG. 4 depicts a schematic diagram of one embodiment of a system employing a reference deallocation memory analysis engine for determining lingering objects located in a heap space;

FIG. 5 depicts a flow chart illustrating one embodiment of a method for optimizing memory usage of a software application;

FIG. 6 depicts a flow chart illustrating one embodiment of a method for determining lingering objects located in an object reference graph associated with a heap structure; and

FIG. 7 depicts a flow chart illustrating another embodiment of a method for determining lingering objects located in an object reference graph associated with a heap structure.

### DETAILED DESCRIPTION OF THE DRAWINGS

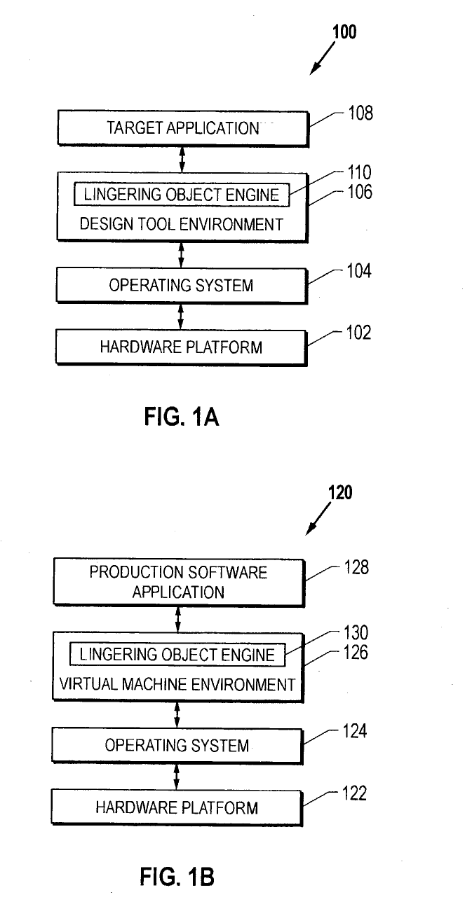

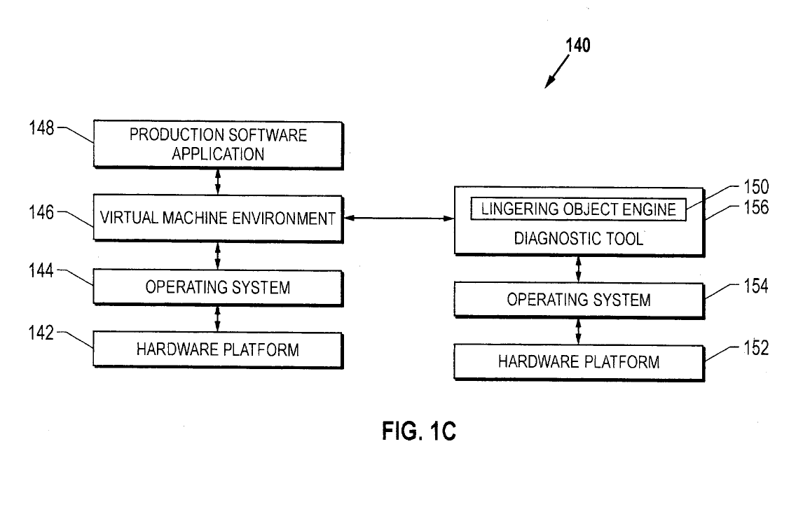

In the drawings, like or similar elements are designated with identical reference numerals throughout the several views thereof, and the various elements depicted are not necessarily drawn to scale. Referring now to FIG. 1A, therein is depicted a computer system 100 that effectuates a development or debug environment in which a lingering object engine embodying the teachings described herein is supported. A hardware platform 102 may be a sequential or a parallel processing machine that provides the physical computing machinery on which an operating system (OS) 104 is employed. The OS may be UNIX, HP-UX®, Sun® Solaris®, Windows® NT®, Linux, or other OS that manages the various software and hardware operations of the computer system 100. A design tool environment 106 provides the utilities to write and compile source code of a target application 108 in an object oriented programming language and, in particular, in an object oriented language wherein programmers do not explicitly free allocated memory. The target application 108 may be written in Java, Eiffel, C#, or other interpretive language developed for manipulation of symbolic strings and recursive data. As will be described in further detail hereinbelow, a lingering object engine 110 is operable to determine which objects in the heap may be deemed as lingering objects, thereby facilitating the optimization of the target software application's memory usage.

FIG. 1B depicts a computer system 120 that effectuates a production environment in which a lingering object engine embodying the teachings described herein is supported. Similar to FIG. 1A, a hardware platform 122 and an OS 124 provide the underlying physical components, and software and resource allocation control components, respectively. It should be appreciated, however, that the hardware platform 122 and the OS 124 may be different from the hardware platform 102 and the OS 104 described in FIG. 1A. A virtual machine environment 126 provides an abstraction layer between the OS 124 and an application layer that allows a compiled application 128 to operate independently of the hardware and software architecture of the system 120. One skilled in the art should further appreciate that the form and functionality of the virtual machine will vary depending on the computer programing language employed. For example, if the Java programing language is employed, the virtual machine environment 126 may take the form of a Java virtual machine (JVM).

In addition to imparting program portability and interoperability, the virtual machine environment stores objects created by the executing compiled application 128 in a heap. Via a process referred to as garbage collection, the virtual machine environment 126 maintains the heap by automatically freeing objects that are no longer referenced by the compiled application 128. A lingering object engine 130 employs the teachings described herein to determine which objects in the heap may be deemed as lingering objects, thereby facilitating the optimization of the memory usage by the software application 128 in a production environment.

FIG. 1C depicts a functional block diagram of an embodiment of a system 140 where a lingering object engine 150 provided as part of a diagnostic tool 156 is utilized with respect to a production software application 148 run in a virtual machine environment 146. The production application and diagnostic tool environments supported by independent hardware platforms 142 and 152, respectively, each platform having its own OS environment 144 or 154. Essentially, system 140 incorporates the features depicted in both FIGS. 1A and 1B described above. In addition to the functionality described hereinbelow, the lingering object engines depicted in these FIGS. may therefore be integrated with a performance analysis tool, such as the HPjmeter analysis tool designed for the Java programming and application environments.

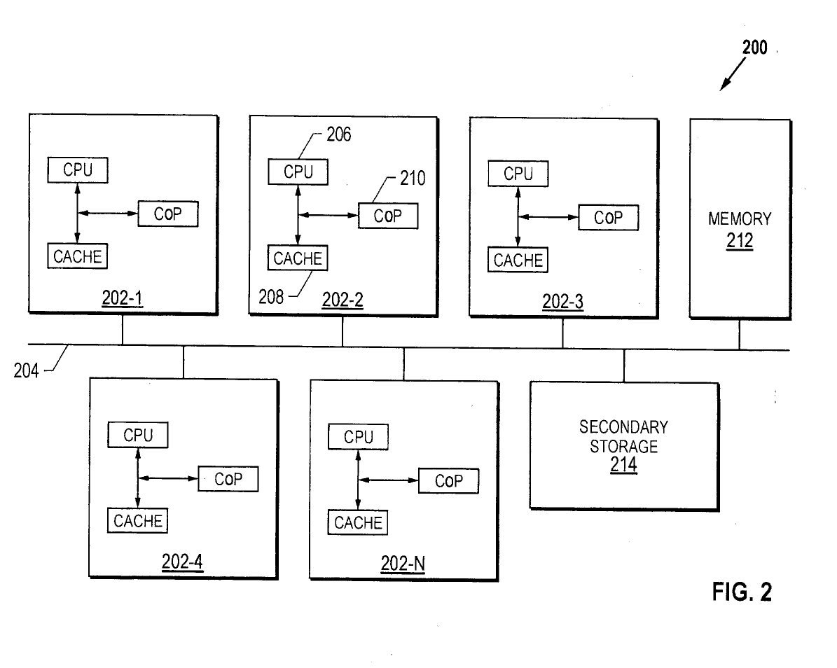

FIG. 2 depicts a hardware platform which includes a multiprocessing (MP) system 200 for supporting the lingering object engine of FIG. 1A, FIG. 1B or FIG. 1C in one exemplary embodiment. Reference numerals 202-1 through 202-N refer to a plurality of processor complexes interconnected together via a high performance, MP-capable bus 204. Each processor complex, e.g., processor complex 202-2, is comprised of a central processing unit (CPU) 206, a cache memory 208, and one or more coprocessors 210. In one implementation, the MP system 200 may be architectured as a tightly coupled symmetrical MP (SMP) system where all processors have uniform access to a main memory 212 and any secondary storage 214 in a shared fashion. As an SMP platform, each processor has equal capability to enable any kernel task to execute on any processor in the system. Whereas threads may be scheduled in parallel fashion to run on more than one processor complex, a single kernel controls all hardware and software in an exemplary implementation of the MP system 200, wherein locking and synchronization strategies provide the kernel the means of controlling MP events.

Continuing to refer to FIG. 2, each processor complex may be provided with its own data structures, including run queues, counters, time-of-day information, notion of current process(es) and priority. Global data structures, e.g., heaps, available for the entire MP system 200 may be protected by means such as semaphores and spinlocks, and may be supported by secondary storage 214. Furthermore, in other implementations of the MP system, the processors can be arranged as “cells” wherein each cell is comprised of a select number of processors (e.g., 4 processors), interrupts, registers and other resources such as, e.g., Input/Output resources. In a production environment, for example, the MP system 200 may operate as a high-performance, non-stop sever platform for running mission-critical software applications in object oriented languages capable of effectuating a large number of transactions. In such environments, thousands of objects may be created having complex referential relationships that can pose severe constraints on heap usage unless efficiently managed.

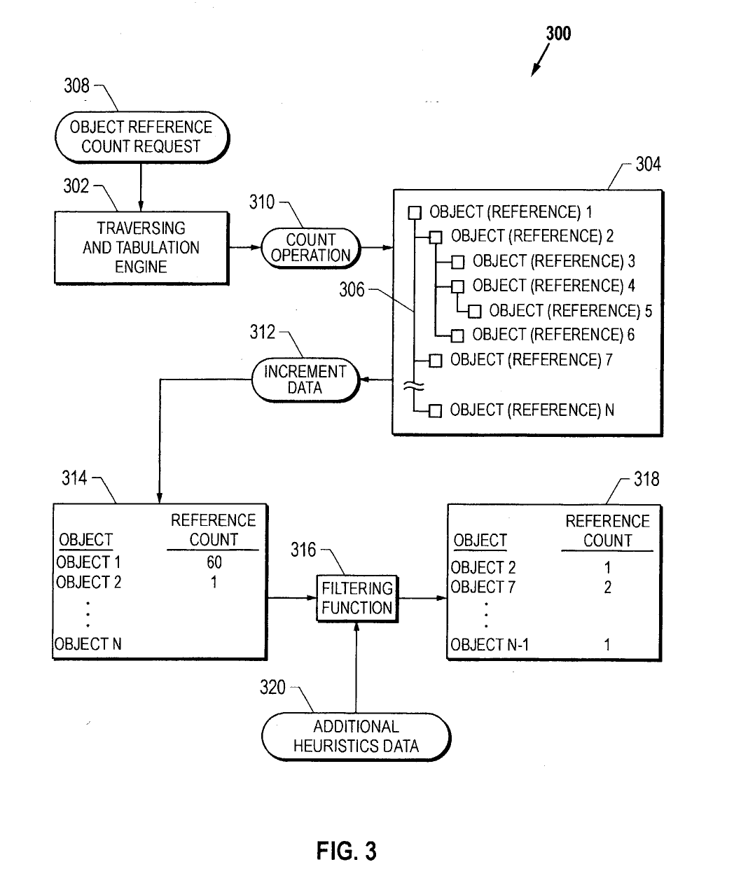

FIG. 3 depicts one embodiment of a system 300 employing a traversing and tabulation engine 302 for determining lingering objects located in a heap space 304. As depicted, objects created pursuant to executing a software application may be arranged as a complex mesh of inter-object references, for example, in an object reference graph 306 that occupies at least a portion of the heap space 304. The heap space 304 provides a runtime data area from which memory may be allocated to objects which may be arrays or any class instance such as fields, methods, interfaces, and nested classes. It should be appreciated that the object components will depend on the computer programming language and virtual machine environment employed, for example. The heap space 304 may be accessed by a profiler utility interacting with the executing program after the program has executed long enough to reach a steady state under a representative or target workload. Accordingly, the instantiated object reference graph 306 includes all of the objects created by an executing program as represented in a hierarchical relationship as OBJECT 1 through OBJECT N. Each object may refer to other objects within the object reference graph 306 as indicated by the REFERENCE designation. It will be apparent that an object may refer to no objects, one object, or multiple objects including itself.

The traversing and tabulation engine 302, which may be a module in the lingering object engine, is operable to traverse the object reference graph 306 in response to receiving an object reference count request 308 which may by produced automatically or manually from the design tool environment or virtual machine environment. Upon receiving the request 308, the traversing and tabulation engine 302 initiates a count operation 310 on the object reference graph 306 wherein as the engine 302 traverses the object reference graph and encounters an object, the engine 302 returns increment data 312 that is indicative of the encountered object's references. In one implementation, the traversing and tabulation engine 302 may traverse the object reference graph 306 in a recursive depth-first fashion. For example, upon encountering OBJECT(REFERENCE) 7, the traversing and tabulation engine returns the names of the objects that references OBJECT(REFERENCE)7 as the increment data 312.

The increment data 312 may be stored in a raw data structure 314 as indicated by the object column and reference count column, which reflect the number of times a particular object has been referenced. A filter function 316 applies a probabilistic heuristic profile in the form of a predetermined count criterion to the data in the raw data structure 314 to filer out the objects deemed to be lingering. In the context of the present patent application, the term “heuristics” refers to techniques involving parametric data that measure or relate to a physical property, e.g., size, count, et cetera, associated with the objects of a reference graph. In one embodiment, the filter function 316 operates on the premise that lingering objects are a result of a programming error which causes a reference to a no-longer-needed object to be retained by another object unintentionally. The number of references to an object may therefore be deemed as indicative of whether or not the object is lingering. In one implementation, the predetermined count criterion is a value ranging between about 1-10. For example, if the value is two and the number of references to an object is one or two, the object is deemed to be lingering.

The filter function 316 outputs all objects deemed to be lingering to a filtered data structure 318 which indicates the lingering objects by an object column and reference count column. The objects in the filtered data structure 318 may be subsequently deallocated automatically or the information in the filtered data structure may be presented to a programmer or an end user in the form of a menu, such as a reference graph tree menu, that allows the programmer to judge which references should be deallocated. In this manner the system described herein finds lingering objects located within a heap space so as to facilitate the optimization of the memory usage of the software application. In one embodiment, as will be explained in more detail hereinbelow, the filter function 316 may employ additional heuristics data 320 representative of the results of other engines or performance analysis tools in its filtering analysis.

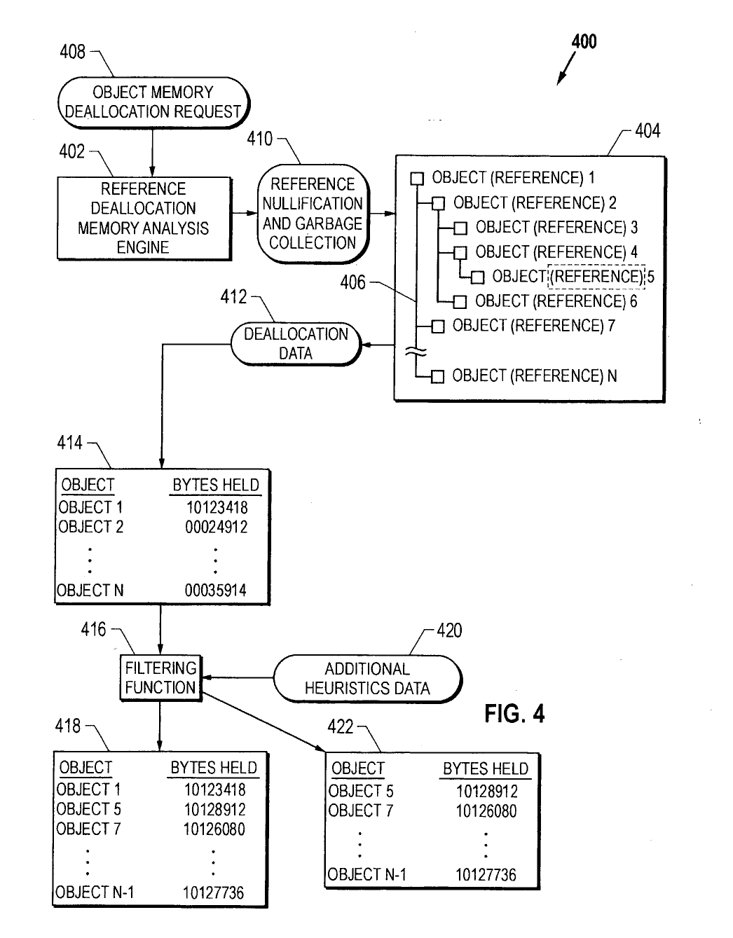

FIG. 4 depicts one embodiment of a system 400 employing a reference deallocation memory analysis engine 402 for determining lingering objects located in a heap space 404. Similar to FIG. 3, an object reference graph 406 occupying at least a portion of the heap space 404 includes all of the objects having references created by an executing program. The objects are represented in a hierarchical relationship as OBJECT(REFERENCE)1, OBJECT(REFERENCE)2, . . . , OBJECT(REFERENCE)N. The reference deallocation memory analysis engine 402 is operable to determine the amount of memory that could be deallocated by nullifying all the references to a particular object.

Upon receiving an object memory deallocation request 408 from the lingering object engine shown in FIG. 1A, FIG. 1B or FIG. 1C, for example, the deallocation memory analysis engine 402 may initiate a reference nullification and garbage collection operation 410 for each object of the object reference graph 406, a sub-tree portion of the object reference graph 406, or for one object. On each object the operation 410 is being performed, all references to that object are found and removed and the amount of memory, expressed in bytes, that could be deallocated from the heap space 404 by a garbage collection operation is determined and returned as deallocation data 412. For example, as illustrated, the reference nullification and garbage collection operation 410 is being performed on OBJECT 5. Accordingly, all references to OBJECT 5 are removed. The object OBJECT(REFERENCE)4 contains a reference to OBJECT 5 so the reference to OBJECT 5 is removed as indicated by the dashed lines around the REFERENCE portion of OBJECT(REFERENCE)5.

The increment data 412 may be stored in a raw data structure 414 as indicated by the object column and the bytes held column. A filter function 416 is operable to apply a probabilistic heuristic profile in the form of a predetermined memory criterion to filer out objects from the raw data structure 414 deemed to be lingering and store these objects in a filtered data structure 418 as indicated by the column headings “object” and “bytes held.” In one embodiment, the filter function employs a “Bytes Held” metric that determines that an object is lingering if the amount of memory that would become free when the object and the references that point to that object are removed exceeds a threshold value. For example, if the threshold is 10100000 bytes then OBJECT 1, OBJECT 5, OBJECT 7, and OBJECT N-1 are deemed lingering objects.

In a further embodiment, the filter function 416 is also operable to employ a composite criterion that evaluates objects based on the results of the traversing and tabulation engine 302 of FIG. 3 and the reference deallocation memory analysis engine 402. In particular, if the number of references to an object is within a predetermined range and these references that point to the object represent an amount of deallocatable memory that is greater than a threshold value, then the object is deemed to be lingering. Thus, an embodiment of the present invention offers a suitable metric, i.e., a numerical value, associated with objects so as to help assess the impact of the possibly lingering objects on the heap in a measurable way.

Continuing with the illustrated example, the filter function 416 accesses additional heuristics data 420 which includes the data stored in filtered data structure 318 of FIG. 3. The filter function 416 then filters the objects in the raw data structure 414 and determines an object to be lingering if the reference count of the object is one or two and the one or two references that point to the object hold an aggregate amount of memory in excess of 10100000 bytes. As depicted in the filtered data structure 422, the objects that meet this set of predetermined heuristic criteria include OBJECT 5, OBJECT 7, and OBJECT N-1. In some applications, this composite criterion may provide a better profile of the objects for determining whether they are lingering. For example, although the references that point to OBJECT 1 hold an aggregate amount of memory in excess of 10100000 bytes, it has a reference count of 60 which suggests that OBJECT 1 is repeatedly and intentionally referenced in the executing program. Hence, OBJECT 1 is not determined to be lingering and not included in the filtered data structure 422. The objects listed in the filtered data structures 418 or 422 may be automatically or manually removed in a manner similar to that described hereinabove with reference to FIG. 3. An efficient methodology for estimating the number of bytes that can be reclaimed by a garbage collector when an object is removed from a heap is described in the following U.S. Patent Application, “A SYSTEM AND METHOD FOR DETERMINING DEALLOCATABLE MEMORY,” cross-referenced hereinabove and incorporated by reference herein.

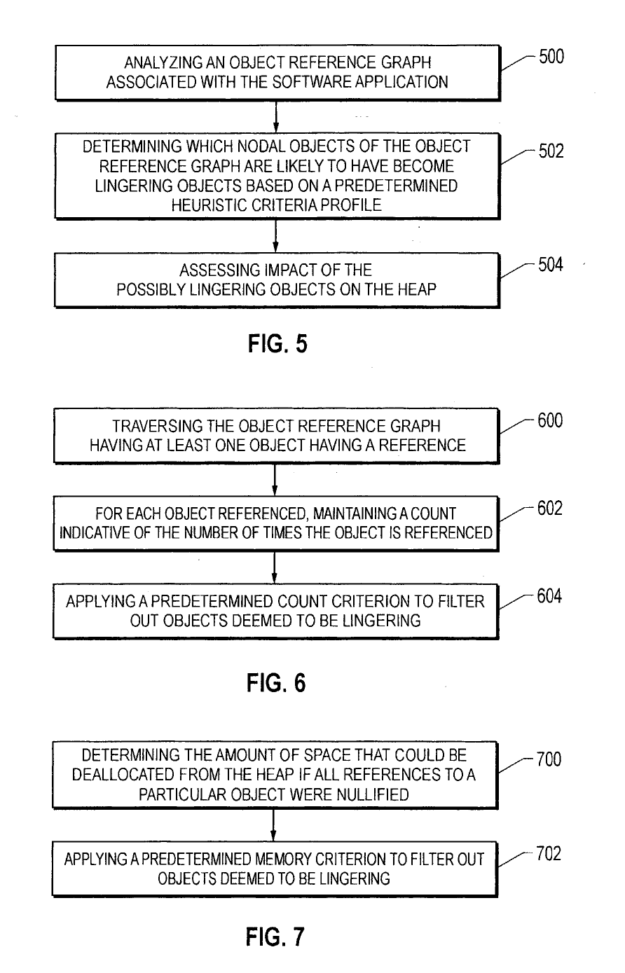

FIG. 5 depicts one embodiment of a method for optimizing memory usage of a software application. At block 500, an object reference graph associated with the software application is analyzed. The analysis performed may include traversing the object reference graph to perform a tabular analysis and/or performing a reference deallocation analysis. At block 502, a predetermined heuristic criteria profile is employed to determine which objects of the object reference graph are likely to become or have become lingering objects. In one embodiment, the predetermined heuristic criteria profile comprises a composite profile employing reference count data and deallocatable memory data. At block 504, the impact of the possibly lingering objects (i.e., those objects determined to satisfy the heuristic criteria profile) may be assessed based on a suitable metric. Such a metric may also be employed for determining whether an object should be removed from the heap, either automatically or manually. Since this method is time-independent, i.e., two or more snap shots of the heap are not necessarily required, computationally intensive operations are not repeatedly performed. Accordingly, the method provides a scalable memory optimization solution that may be employed in small applications or larger server-side applications.

FIG. 6 depicts one embodiment of a method for determining lingering objects located in an object reference graph associated with a heap structure. At block 600, the object reference graph having at least one object having a reference is traversed. At block 602, for each object referenced, a count is maintained that is indicative of the number of times an object is referenced. At block 604, a predetermined count criterion is applied to filter out objects deemed to be lingering.

FIG. 7 depicts another embodiment of a method for determining lingering objects located in an object reference graph associated with a heap structure. At block 700, the amount of deallocatable space is determined that could be deallocated from the heap if all references to a particular object were nullified. At block 702, a predetermined memory criterion is applied to filter out objects deemed to be lingering. As previously discussed, the count data provided by the method of FIG. 6 may be cross-referenced with the memory criterion of FIG. 7 to provide a more comprehensive performance analysis tool for optimizing memory usage.

Although the invention has been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

What is claimed is:

1. A method for optimizing memory usage of a software application:
analyzing an object reference graph associated with said software application, wherein said object reference graph is instantiated in a heap;
determining which objects of said object reference graph are likely to have become lingering objects based on a heuristic criteria profile; and
assessing impact of said objects determined to satisfy said heuristic criteria profile on said heap.

2. The method as recited in claim 1, wherein the operation of analyzing an object reference graph associated with said software application comprises traversing said object reference graph and performing a reference counting analysis.

3. The method as recited in claim 1, wherein the operation of analyzing an object reference graph associated with said software application comprises performing a reference deallocation memory analysis.

4. The method as recited in claim 1, wherein the operation of analyzing an object reference graph associated with said software application comprises performing at least one of a reference counting analysis and a reference deallocation memory analysis.

5. The method as recited in claim 1, wherein said software application is executed in a design tool environment.

6. The method as recited in claim 1, wherein said software application is executed in a virtual machine environment.

7. The method as recited in claim 1, wherein said software application is executed in a diagnostic tool environment.

8. The method as recited in claim 1, further comprising removing at least one of said objects from said heap based on said assessing operation.

9. The method as recited in claim 8, wherein said operation of removing at least one of said objects comprises automatically removing said object based on a metric associated with said object.

10. The method as recited in claim 8, wherein said operation of removing at least one of said objects comprises manually removing said object based on a metric associated with said object.

11. The method as recited in claim 1, further comprising the operating of repairing said software application based determining which objects are likely to have become lingering objects.

12. A computer-readable medium operable with a computer platform to optimize memory usage of a software application, the medium having stored thereon:
instructions for analyzing an object reference graph associated with said software application, wherein said object reference graph is instantiated in a heap;
instructions for determining which objects of said object reference graph are likely to become lingering objects based on a heuristic criteria profile; and
instructions for assessing impact of said objects determined to satisfy said heuristic criteria profile on said heap.

13. The computer-readable medium as recited in claim 12, wherein said instructions for analyzing an object reference graph associated with said software application comprise instructions for traversing said object reference graph and performing a reference counting analysis.

14. The computer-readable medium as recited in claim 12, wherein said instructions for analyzing an object reference graph associated with said software application comprise instructions for performing a reference deallocation memory analysis.

15. The computer-readable medium as recited in claim 12, wherein said instructions for analyzing an object reference graph associated with said software application comprise instructions for performing at least one of a reference counting and a reference deallocation memory analysis.

16. The computer-readable medium as recited in claim 12, wherein said software application is executed in a design tool environment.

17. The computer-readable medium as recited in claim 12, wherein said software application is executed in a virtual machine environment.

18. The computer-readable medium as recited in claim 12, wherein said software application is executed in a diagnostic tool environment.

19. The computer-readable medium as recited in claim 12, further comprising instructions for removing at least one of said objects from said heap based on said assessing operation.

20. A system for determining lingering objects associated with a software application, comprising:
a heap structure having an object reference graph with at least one object created pursuant to executing said software application;
a tabulation engine operable to traverse said object reference graph and maintain a count indicative of the number of times an object is referenced; and
a filter operable to apply a predetermined count criterion to filter out objects deemed to be lingering.

21. The system as recited in claim 20, wherein said tabulation engine is operable to traverse said object reference graph in a recursive depth-first fashion.

22. The system as recited in claim 20, wherein said predetermined count criterion is a value ranging about 1-10.

23. The system as recited in claim 20, wherein said tabulation engine is operable to traverse an object reference graph created pursuant to executing a software application that is written in a computer language selected from the group consisting of Java, Eiffel, and C#.

24. The system as recited in claim 20, wherein said tabulation engine is operable to traverse an object reference graph created pursuant to executing a software application in a development environment.

25. The system as recited in claim 20, wherein said tabulation engine is operable to traverse an object reference graph created pursuant to executing a software application in a production environment.

26. The system as recited in claim 20, wherein said tabulation engine is operable to traverse an object reference graph created pursuant to executing a software application in a diagnostic tool environment.

27. A method for determining lingering objects located in an object reference graph associated with a heap structure, comprising:
traversing said object reference graph having at least one object having a reference;
for each object referenced, maintaining a count indicative of the number of times an object is referenced; and
applying a predetermined count criterion to filter out objects deemed to be lingering.

28. The method as recited in claim 27, wherein said operation of traversing said object reference graph comprises traversing said object reference graph in a recursive depth-first fashion.

29. The method as recited in claim 27, wherein said predetermined count criterion is a value ranging about 1-10.

30. The method as recited in claim 27, wherein said operation of traversing said object reference graph further comprises traversing said object reference graph created pursuant to executing a software application that is written in a computer language selected from the group consisting of Java, Eiffel, and C#.

31. A system for determining lingering objects associated with a software application, comprising:
a heap structure having an object reference graph with at least one object created pursuant to executing said software application;
a reference deallocation memory analysis engine operable to determine the amount of space that could be deallocated from said heap if all references to a particular object were nullified; and
a filter operable to apply a predetermined memory criterion to filter out objects deemed to be lingering.

32. The system as recited in claim 31, wherein said reference deallocation memory analysis engine incorporates garbage collection functionality to determine the amount of space that could be deallocated from said heap.

33. The system as recited in claim 31, wherein said predetermined memory criterion includes a “Bytes Held” metric.

34. The system as recited in claim 31, wherein said reference deallocation memory analysis engine is operable with respect to an object reference graph created pursuant to executing a software application that is written in a computer language selected from the group consisting of Java, Eiffel, and C#.

35. The system as recited in claim 31, wherein said reference deallocation memory analysis engine is operable to analyze an object reference graph created pursuant to executing a software application in a development environment.

36. The system as recited in claim 31, wherein said reference deallocation memory analysis engine is operable to analyze an object reference graph created pursuant to executing a software application in a production environment.

37. The system as recited in claim 31, wherein said reference deallocation memory analysis engine is operable to analyze an object reference graph created pursuant to executing a software application in a diagnostic tool environment.

38. A method for determining lingering objects located in an object reference graph associated with a heap structure, comprising:
determining the amount of space that could be deallocated from said heap if all references to a particular object were nullified; and
applying a predetermined memory criterion to filter out objects deemed to be lingering.

39. The method as recited in claim 38, wherein said operation of determining the amount of space incorporates garbage collection functionality to determine the amount of space that could be deallocated from said heap.

40. The method as recited in claim 38, wherein said predetermined memory criterion includes a “Bytes Held” metric.

41. The method as recited in claim 38, wherein said operation of determining the amount of space further comprises determining the amount of space that could be deallocated from said heap created pursuant to executing a software application that is written in a computer language selected from the group consisting of Java, Eiffel, and C#.

42. A method for determining lingering objects located in an object reference graph associated with a heap structure, comprising:
for each object referenced, maintaining a reference count indicative of the number of times an object is referenced;
determining the amount of deallocatable space that could be freed from said heap structure if all references to a particular object were nullified; and
applying a heuristic criterion based on said reference count and said deallocatable space to filter out objects deemed to be lingering.

43. The method as recited in claim 42, further comprising the operation of traversing said object reference graph in a recursive depth-first fashion.

44. The method as recited in claim 42, wherein said operation of determining the amount of deallocatable space further comprises determining the amount of space that could be freed from said heap created pursuant to executing a software application that is written in a computer language selected from the group consisting of Java, Eiffel, and C#.

45. The method as recited in claim 42, wherein said heuristic criterion includes a “Bytes Held” metric.

46. A system for optimizing memory usage of a software application, comprising:
means for analyzing an object reference graph associated with said software application, wherein said object reference graph is instantiated in a heap;
means for determining which objects of said object reference graph are likely to have become lingering objects based on a heuristic criteria profile; and
means for assessing impact of said objects determined to satisfy said heuristic criteria profile on said heap.

47. A computer, comprising:
means for analyzing an object reference graph associated with a software application, wherein said object reference graph is instantiated in a heap;
means for determining which objects of said object reference graph are likely to have become lingering objects based on a heuristic criteria profile; and
means for assessing impact of said objects determined to satisfy said heuristic criteria profile on said heap.
